(19) United States
(12) Patent Application Publication
(10) Pub. No.: US 2026/0229564 A1
(43) Pub. Date: Aug. 6, 2026

(54) METHOD FOR MODEL-BASED OPERATION OF A COOLANT SYSTEM, CONTROL UNIT AND FUEL CELL SYSTEM

(71) Applicant: Robert Bosch GmbH, Stuttgart (DE)

(72) Inventors: Christian Dullinger, St. Pölten (AT); Thomas Bleile, Stuttgart-Zuffenhausen (DE); Alexander Metzger, Bad Vöslau (AT)

(21) Appl. No.: 19/150,231

(22) PCT Filed: Feb. 7, 2024
(86) PCT No.: PCT/EP2024/053059

§ 371 Date: Jul. 23, 2025

(30) Foreign Application Priority Data
Feb. 9, 2023 (DE) 10 2023 201 055.0

(51) Int. Cl. H01M 8/04701; C25B 15/027; H01M 8/0432

(52) U.S. Cl. CPC H01M 8/04723; C25B 15/027; H01M 8/04358

(57) ABSTRACT

The invention relates to a method for model-based operation, in particular open-loop and/or closed-loop control, of a coolant system (10), preferably for operation of an electrochemical energy converter, preferably a fuel cell system (100) or an electrolyzer,

comprising the following steps:
determining a temperature range (T1(i), T2(i)) for at least one subsystem of the coolant system (10),
approximating a temperature-dependent specific heat capacity (cₚ(T)) of a coolant of the coolant system (10) for the determined temperature range (T1(i), T2(i)),
determining a specific enthalpy (h) of the coolant as a function (h(T)) of a temperature (T) on the basis of the approximation,
operating the coolant system (10) on the basis of the determination.

### SUMMARY

The invention relates to a method for model-based operation, in particular open-loop and/or closed-loop control, of a coolant system, preferably for operation of an electrochemical energy converter, preferably a fuel cell system or an electrolyzer. The invention also relates to a corresponding computer program product, a corresponding control unit and a corresponding fuel cell system.

For many liquids (e.g., water), the specific heat capacity is considered constant. However, there are a number of fluids (e.g., coolant in coolant circuits) for which this assumption is not warranted. Therefore, consideration of the temperature dependence of the specific heat capacity in a thermal model improves the accuracy of the model. Such a thermal model (e.g., the thermal model of the mixing point in which the coolant of the cooler path mixes with the coolant of the bypass path; the thermal model of the fuel cell stack; the thermal model of the cooler; etc.) may be used by a model-based controller (e.g., applied in the fuel cell control unit), to control the actuators of a coolant circuit (e.g., cooler bypass valve and coolant pump in a coolant circuit for a fuel cell stack). It should be mentioned at this point that in a coolant circuit, the following temperatures are usually to be controlled for a fuel cell stack. Using the cooler bypass valve as the actuator, the coolant inlet temperature of the fuel cell stack is controlled. A coolant pump as an actuator is used to control the coolant outlet temperature of the fuel cell stack (or the coolant differential temperature between the coolant outlet temperature and the coolant inlet temperature). Using the cooler fans as actuators, the coolant outlet temperature of the cooler is controlled. A model-based pilot control or a model-based closed-loop control or a model-based observer therefore requires a thermal model of the mixing point or fuel cell stack or cooler. The analytical equations of a thermal model require the specific enthalpy and (also in the case of a dynamic thermal model) the specific heat capacity as a function of fluid temperature to model power or energy balances. In addition, such a thermal model requires the reverse function, which calculates the fluid temperature T as a function of the specific enthalpy of the coolant. There are many methods of obtaining the specific enthalpy from the specific heat capacity, with various advantages and disadvantages in terms of accuracy, form/predictability of the reversing function for temperature, consumption of software resources (for storing parameters or performing calculations), etc.

The present invention provides: a method for model-based operation, in particular open-loop and/or closed-loop control, of a coolant system, preferably for operation of an electrochemical energy converter, preferably a fuel cell system or an electrolyzer. The invention further provides a corresponding computer program, a corresponding control unit and a corresponding fuel cell stack having the features of the disclosure. In this context, features and details described in connection with the various embodiments and/or aspects of the invention clearly also apply in connection with the other embodiments and/or aspects of the invention, and respectively vice versa, so, with respect to the disclosure, mutual reference to the individual embodiments and/or aspects of the invention is or can always be made.

The present invention provides, according to a first aspect, a method for model-based operation, in particular open-loop and/or closed-loop control, of a coolant system, in particular for operation of an electrochemical energy converter, preferably a fuel cell system or an electrolyzer. The coolant system may comprise at least one subsystem or multiple subsystems. Reference to exemplary subsystems of a coolant system will be made in detail in the following.

The method comprises the following method steps/actions:
determining a temperature range for at least one subsystem of the coolant system (or for each subsystem of the coolant system or for the entire coolant system),
in particular for a thermal model of the at least one subsystem (or each thermal model for each subsystem of the coolant system or a thermal model of the entire coolant system),
e.g., the thermal model of a mixing point in which the coolant of a cooler path (or coolant path through a cooler) mixes with the coolant of a bypass path; and/or
the thermal model of a coolant path by a fuel cell stack of the fuel cell system or by an electrolyzer; and/or
the thermal model of a coolant path through a cooler; etc.,
wherein in particular the (currently relevant) temperature range is determined (e.g., calculated) from known temperatures,
approximating, in particular using linear approximation, a temperature-dependent specific heat capacity of a coolant in the coolant path of the at least one subsystem of the coolant system for the particular (i.e., currently relevant) temperature range, in particular for the respective thermal model,
determining a specific enthalpy of the coolant as a function of a temperature on the basis of approximation (meaning the temperature-dependent specific heat capacity),
in particular comprising: calculating the enthalpy currents relevant to the respective thermal model on the basis of the approximated temperature-dependent specific heat capacity,
operating the coolant system on the basis of the determination (meaning the specific enthalpy of the coolant as a function of a temperature),
respectively comprising: calculating a manipulated variable for operating a coolant system, calculating a pilot value for at least one manipulated variable, calculating a value for at least one manipulated variable, and/or possibly calculating observed variables using the respective thermal model, etc.

A coolant system can be understood to mean any temperature control system that can enable a temperature control of a fuel cell stack of a fuel cell system by means of a cooling fluid or coolant.

The coolant may generally be referred to as a tempering agent.

In some modes of operation of the fuel cell system, such as for a freeze start and/or a cold start, the coolant system may serve to warm the fuel cell stack to appropriate operating temperatures. In turn, in other modes of operation of the fuel cell system, such as during normal operation, high-load operation, etc., the coolant system may serve to cool the fuel cell stack to appropriate operating temperatures.

A coolant system within the scope of the present disclosure may include a coolant pump for circulating the coolant. In addition, the coolant system may include a cooler bypass valve (the valve position sets the mixing ratio of the coolant flows that are mixed in a so-called mixing point of the coolant system, e.g., in the form of a three-way valve), to direct the coolant to a part through the cooler (e.g., radiator) and/or to another part past the cooler.

For example, a subsystem of the coolant system may be a mixing point where the coolant of the cooler path mixes with the coolant of the bypass path. For the thermal model of the mixing point (i.e. the modeled subsystem of the coolant system is the mixing point), the currently relevant temperature range (for approximation of the temperature-dependent specific heat capacity for this thermal model) may be determined, for example by the coolant temperature prevailing in the cooler path, preferably just before the mixing point, and the coolant temperature prevailing in the bypass path, preferably just before the mixing point.

For example, a subsystem of the coolant system may be a coolant path through a fuel cell stack of the fuel cell system. For the thermal model of the coolant path through the fuel cell stack (i.e. the modeled subsystem of the coolant system is the coolant path through the fuel cell stack), the currently relevant temperature range (for approximation of the temperature-dependent specific heat capacity for this thermal model) may be determined, for example, by the coolant temperature prevailing in the coolant path, preferably just before the fuel cell stack, and the coolant temperature prevailing in the coolant path, preferably just after the fuel cell stack. If one of these temperatures is not yet known for the time step i (e.g., since it has not yet been calculated), the already known temperature from the previous time step (i.e., from the time step i-1) can be used.

For example, a subsystem of the coolant system may be a coolant path through a cooler. For the thermal model of the cooler (i.e. the modeled subsystem of the coolant system is the coolant path through the cooler), the currently relevant temperature range (for approximation of the temperature-dependent specific heat capacity for this thermal model) may be determined, for example, by the coolant temperature prevailing in the cooler path, preferably just before the cooler, and the coolant temperature prevailing in the cooler path, preferably just after the cooler. If one of these temperatures is not yet known for the time step i (e.g., since it has not yet been calculated), the already known temperature from the previous time step (i.e., from the time step i-1) can be used.

The enthalpy currents relevant to the respective thermal model on the basis of the approximated temperature-dependent specific heat capacity can be calculated as follows: The specific enthalpy of the coolant at the respective relevant location of the thermal model is, preferably linearly, determined preferably by analytical integration of the function that approximates the temperature-dependent specific heat capacity in the relevant temperature range. Using physics, the enthalpy flow of the coolant at the respective relevant location of the thermal model is then clearly obtained by multiplying the specific enthalpy of the coolant at the location with the coolant mass flow at the location.

The enthalpy currents relevant to the particular thermal model (e.g., the thermal model of the mixing point in which the coolant of the cooler path mixes with the coolant of the bypass path; the thermal model of the fuel cell stack; the thermal model of the cooler; etc.) may then be used in the power balance(s) of the thermal model. The calculation of the pilot value of the at least one manipulated variable and/or the calculation of the value of the at least one manipulated variable or possibly the calculation of observed variables can then be carried out via the equations of the respective thermal model.

It is recognized that assuming a constant specific heat capacity to calculate an enthalpy flow through the coolant system during operation of the fuel cell system may result in significant deviations in pilot control, which in turn may result in significant effort in correcting the temperatures by the subsequent closed-loop control. Consequently, the assumption of a constant specific heat capacity may result in degraded closed-loop performance.

It is also recognized that using average values for the specific heat capacity when controlling the coolant system can also lead to noticeable errors in calculating the heat input.

The method utilizes the fact that certain values for the specific heat capacity are known on the basis of the temperature from a data sheet for the specific coolant.

Advantageously, using the method, the specific enthalpy can be calculated in an efficient manner on the basis of the temperature-dependent specific heat capacity. Using the method, the inverse function for the temperature (i.e. the coolant temperature) can also be efficiently calculated on the basis of the specific enthalpy. Moreover, both the specific heat capacity and the specific enthalpy are calculated with high accuracy. To do this, only a few (e.g., three) calibration parameters (storage elements) need to be stored to describe the functions of the specific heat capacity, the specific enthalpy and the temperature. Thus, the proposed method saves software resources for both the calculations and the storage elements.

The physical relationship between the specific heat capacity, the specific enthalpy and the temperature will be described in detail below using the figure description.

Further, it may be provided that the method is performed in real time during operation of the coolant system (e.g., for a fuel cell system). By this, the accuracy of the thermal models can be improved. Thus, the method can efficiently improve an open-loop or closed-loop control of a coolant system.

Further, it may be provided that approximating the temperature-dependent specific heat capacity of the coolant is performed only for the determined temperature range. In this way, approximation may be performed only for the particular (i.e., currently relevant) temperature range, in particular for the respective thermal model.

Furthermore, it may be provided that the method is performed repeatedly. In this way, the method may be performed periodically, incrementally, or even event-specifically, for example when the temperature changes.

In addition, it can be provided that the method is carried out incrementally, in particular at certain time intervals. In this way, a simple implementation of the method can be enabled in terms of control technology.

Further, it is contemplated that the at least one subsystem of the coolant system comprises a coolant path through an electrochemical energy converter, in particular through a fuel cell stack of a fuel cell system or through an electrolyzer, Further, it is contemplated that the at least one subsystem of the coolant system comprises a coolant path through a cooler and/or at least one mixing point of the coolant system. Using the method, the respective thermal model may be improved for at least one subsystem of the coolant system, for multiple subsystems of the coolant system, or even for the entire coolant system.

It can also be provided that the method is performed by a control unit, in particular a central control unit of the fuel cell system. Thus, an improved calculation of the pilot value of the at least one manipulated variable and/or the calculation of the value of the at least one manipulated variable or possible calculation of observed variables via the respective thermal model can be enabled. In addition, this may improve operation of the fuel cell system.

Prior to approximating the temperature-dependent specific heat capacity of the coolant, a data sheet for the specific heat capacity of the coolant can be used on the basis of the temperature to describe the temperature-dependent specific heat capacity. In this way, the data available via the coolant may be used in an advantageous manner.

Advantageously, when approximating the temperature-dependent specific heat capacity of the coolant, a first degree polynomial is used. Thus, the data about the coolant available may be approximated in an advantageous manner using functions (on the basis of the temperature), which may in turn be integrated over a relevant temperature range in order to be able to determine the specific enthalpy of the coolant at a particular location in the cooling circuit. Finally, knowing the specific enthalpy of the coolant, the enthalpy flow at a particular location in the cooling circuit may be calculated by multiplying the coolant mass flow at that location.

Further it can be provided that when determining the specific enthalpy of the coolant as a function of the temperature, the temperature-dependent specific heat capacity of the coolant is initially approximated over the determined temperature range using a, preferably linear, function and then the approximated, preferably linear, function is analytically integrated. Thus, improved open-loop and/or closed-loop control of a coolant system may be facilitated without much effort.

According to a further aspect, the invention provides a computer program product comprising instructions that, when the computer program product is executed by a computer, e.g., the computing unit of the control unit prompts the computer to perform the method, which can proceed as described hereinabove. The computer program product may be used to achieve the same advantages described above in connection with the method according to the method. Full reference is made to these advantages in the present case.

A corresponding control unit provides a further aspect of the invention. A computer program in the form of a code may be stored in a memory unit of the control unit, which, when the code is executed by a computing unit of the control unit, carries out a procedure which can run as described above. With the aid of the control unit, the same advantages may be achieved as described above in connection with the method according to the invention. Full reference is made to these advantages in the present case.

A corresponding fuel cell stack with a corresponding control unit provides a further aspect of the invention. With the aid of the fuel cell stack, the same advantages may be achieved as described above in connection with the method according to the invention. Full reference is made to these advantages in the present case.

### BRIEF DESCRIPTION OF THE DRAWINGS

Preferred exemplary embodiments:

The invention and the embodiments, as well as the advantages thereof, are explained in further detail hereinafter with reference to the drawing. It shows schematically in each case:

FIG. 1 a data sheet of a coolant having a temperature-dependent specific heat capacity,

FIG. 2 a linear approximation of a temperature-dependent specific heat capacity in the currently (i.e. at the time step i) relevant temperature range (defined by T1(i) and T2(i)) for the respective thermal model, and

FIG. 3 an exemplary coolant system for a fuel cell system.

### DETAILED DESCRIPTION

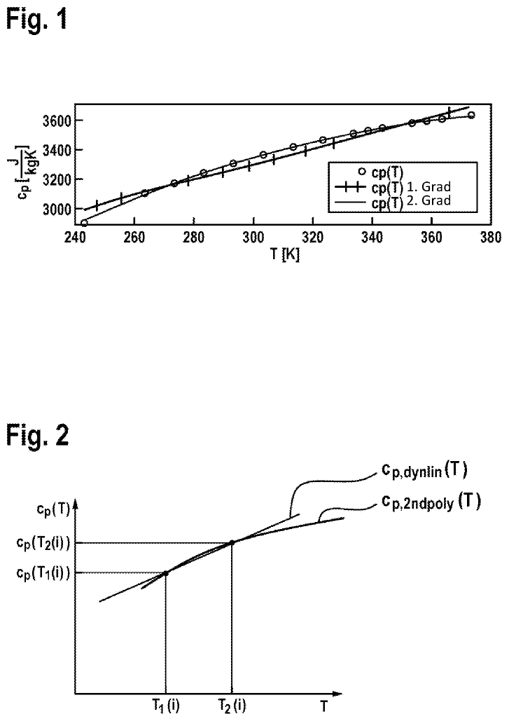

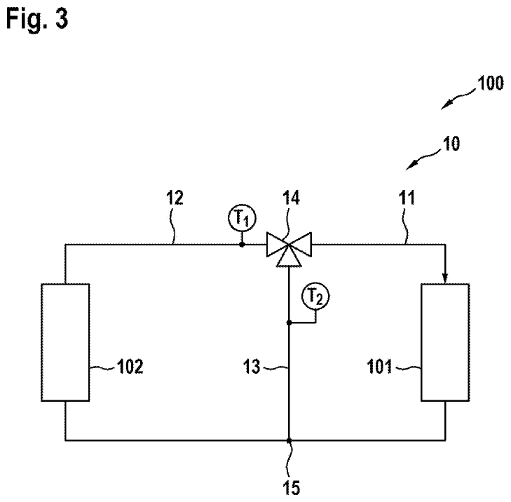

FIGS. 1-3 serve to explain a proposed method. The method is developed for the model-based operation, in particular open-loop control and/or closed-loop control, of a coolant system 10, which is shown schematically in FIG. 3, and which may be used, for example, to operate a fuel cell system 100 or an electrolyzer.

The method comprises the following method steps/actions:
determining a (in particular currently relevant) temperature range T1(i), T2(i) for at least one subsystem of the coolant system 10,
wherein the respective subsystem e.g., can comprise a mixing point 14 in which the coolant of a cooler path 12 mixes with the coolant of a bypass path 13 (cf. FIG. 3); a coolant path 11 through a fuel cell stack 101; a coolant path through a cooler 102; etc.,
(preferably linear) approximation of a temperature-dependent specific heat capacity cₚ(T) of a coolant in the at least one subsystem of the coolant system 10 for the particular (in particular currently relevant) temperature range T1(i), T2(i),
in particular of the respective thermal model,
determining a specific enthalpy of the coolant as a function h(T) of a temperature T on the basis of approximation (meaning the temperature-dependent specific heat capacity cₚ(T)),
in particular determining the specific enthalpy h of the coolant at the respective relevant location of the respective thermal model, by preferably analytical integration of a function that, preferably linearly, approximates the temperature-dependent specific heat capacity cₚ(T) in the relevant temperature range T1(i), T2(i),
preferably calculating the enthalpy streams relevant to the respective thermal model, preferably by multiplying the specific enthalpy h of the coolant determined in this way with the respective associated coolant mass flow at this location,
operating the coolant system 10 on the basis of the determination (meaning the specific enthalpy h of the coolant as a function h(T) of a temperature T),
in particular calculating a pilot value for at least one manipulated variable and/or calculating a value for the at least one manipulated variable, or possibly calculating observed variables via corresponding equations of the respective thermal model using the calculated relevant enthalpy flows of the coolant.

The total differential of the specific enthalpy h is:

$$dh = {\underbrace{{( \frac{\partial h}{\partial T} )}_{p}}}_{{c}_{p}} dT + {\underbrace{{( \frac{\partial h}{\partial p} )}_{T}}}_{\approx 0} dp , \qquad ( 1 )$$

The specific heat capacity cₚ of the fluid is needed for dynamic models (e.g., for the thermal model of a fuel cell stack).

In (1), T is the temperature, p is the pressure, and cₚ is the specific heat capacity of the coolant. In the event that the specific heat capacity is temperature-dependent (i.e. cₚ=cₚ(T)), the result is:

$$d h = {c}_{p} ( T ) d T , \qquad ( 2 )$$

Thus, in the case of a temperature-dependent specific heat capacity cₚ(T), the specific heat capacity may not be placed outside the integral for integration of (2), and

$${h}_{B} - {h}_{A} = {c}_{p} \cdot ( {T}_{B} - {T}_{A} ) , \qquad ( 3 )$$

cannot be applied (for integration of (2) from a point A to a point B) and

$${h}_{B} - {h}_{A} = {c}_{p} ( {T}_{B} ) \cdot {T}_{B} - {c}_{p} ( {T}_{A} ) \cdot {T}_{A} , \qquad ( 4 )$$

is consequently not accurate.

Thus, h(T) cannot be calculated simply by multiplying cₚ(T) by T(as depicted in the incorrect equation (4)). Instead, the integration of (2) must be performed either numerically (i.e. numerical integration of the given cₚ(T) data sheet of the fluid) or an analytical function must be adjusted to the data of the given cₚ(T) data sheet and analytically integrated.

FIG. 1 shows a data sheet of an exemplary coolant (e.g., ethylene glycol comprising 50% ethylene and 50% water) with a temperature-dependent specific heat capacity cₚ(T). The specific heat capacity cₚ of the coolant varies greatly with temperature T. In addition, FIG. 1 shows the approximation of the specific heat capacity cₚ as a first degree polynomial (i.e., a linear approximation) and as a second degree polynomial (i.e., a square approximation) to the overall data of the data sheet.

As can be seen from FIG. 1, the conformity of the second degree polynomial with the data from the data sheet is significantly better than that of the first degree polynomial. Preferably, therefore, a second degree polynomial is adjusted to the entire data sheet (offline) (see equation (5)) and linearly approximated by the method in the temperature range currently relevant to the time step i given by T1(i) and T2(i) (online) (see equation (6)).

However, it is also generally conceivable that a different function than the second degree polynomial will be adapted to the data from the data sheet.

According to the method, in each time step i, a new linear approximation (6) of a second degree polynomial (5) (see also FIG. 2) may be used for the specific heat capacity cₚ(T) of the coolant on the basis of the fluid temperature T. In each time step i, this linear approximation (6) can be performed in the current operating range defined by the current and known fluid temperatures T1(i) and T2(i) and integrated via the fluid temperature T in each time step i to obtain the specific enthalpy h(T) as a function of the fluid temperature T.

Note that the slope \hat{k}(i) and the offset-term \hat{d}(i) of the linear approximation (6) of the second degree polynomial (5) used for the specific heat capacity of the fluid as a function of the fluid temperature depends on the time step i. This is because linear approximation (6) is performed only for the operating range T1(i) to T2(i) valid in the time step i and not for the entire data (i.e. for the entire temperature range of the data sheet) given in the data sheet of the coolant (cf. FIG. 1). In (5) and (6), the dependence of the independent variable T from time t (or time step i) is omitted for simplicity reasons to improve the readability of the equations:

$${c}_{p , 2 ndpoly} ( T ) = {\hat{c}}_{p , 0} + {\hat{c}}_{p , 1} \cdot T + {\hat{c}}_{p , 2} {T}^{2} , \qquad ( 5 )$$

$${c}_{p , dynlin} ( T ) = \hat{k} ( i ) \cdot T + \hat{d} ( i ) , \qquad ( 6 )$$

For the approximation range used for the time step i defined by temperatures T1(i) and T2(i), the linear approximations (6) of (5) and also (5) are shown schematically in FIG. 2. It should be noted that temperatures T1(i) and T2(i) (see FIG. 2) thus capture the current temperature range (in which the coolant temperatures are currently moving) and thus the linear approximation (6) focuses on this range and therefore approximates very well.

The advantages of the proposed method include:
high modeling accuracy of physical variables cₚ(T), h(T) and T(h),
a replacement of the coolant only requires a recalibration of the three polynomial coefficients of (5),
an inverse function T(h) is easy to derive/calculate and is derivable/calculable with little computational effort,
reduced resources in computational capacity (only a few calculations are needed quickly and easily),
reduced resources in storage capacity (only a few coefficients need to be stored, in particular only the three polynomial coefficients of (5)),

Instead of fitting a polynomial (e.g., 1st or 2nd degree) once (online) to the entire temperature data range of the cₚ(T) data sheet of FIG. 1, a linear approximation (6) of (5) in the currently relevant temperature range (T1(i) to T2(i)) defined by the current and known temperatures T1(i) and T2(i) is performed in each time step i (online or in real time). In other words, in each time step i, the linear approximation (6) of (5) is performed again taking into account the changed temperature range defined by the known temperatures T1(i) and T2(i).

Based on this linear approximation (6) (i.e. a 1st degree polynomial) the integration of (2) from any temperature T0 (where h(T0) is known by definition) to the temperature T for which the specific enthalpy h(T) is to be calculated results in a 2nd degree polynomial for h(T). The advantage of this 2nd degree polynomial for h(T) is that the reverse function T(h) is easily calculated by the analytical solution of a square equation.

Based on physics, an enthalpy stream can be calculated from the specific enthalpy h(T) simply by multiplying with the associated mass flow dm/dt.

FIG. 3 illustrates an exemplary coolant system 10 for a fuel cell system 100 having at least one fuel cell stack 101. A coolant path 12 passes through a cooler 102. A coolant path 11 passes through the fuel cell stack 101. A coolant circuit for the fuel cell stack 101 may be realized by the coolant path 11 through the fuel cell stack 101 and the coolant path 12 through the cooler 102 and/or a bypass path 13. In the mixing point 14 subsystem, the coolant from the coolant path 12 mixes with the coolant from the bypass path 13 through the cooler 102. The coolant mixed at mixing point 14 flows into coolant path 11 through fuel cell stack 101. A three-way valve may be disposed either at this mixing point 14 or at the branching point 15 where the coolant path 11 is divided by the fuel cell stack 101 onto the coolant path 12 by the cooler 102 and the bypass path 13.

As can be seen from FIG. 3, for the thermal model of the mixing point 14, in which the coolant from the coolant path 12 through the cooler 102 mixes with the coolant of the bypass path 13, the currently relevant temperature range T1(i) to T2(i) (for the approximation of the temperature-dependent specific heat capacity cp(T) for this thermal model) can be determined, for example, by the coolant temperature prevailing in the coolant path 12 through the cooler 102, preferably just before the mixing point 14, and the coolant temperature prevailing in the bypass path 13, preferably just before the mixing point 14.

The preceding description of the embodiments describes the present invention exclusively in the context of examples. Of course, individual features of the embodiments can be freely combined with one another, provided that this is technically meaningful, without departing from the scope of the present invention.

1. A method for model-based operation of a coolant system (10) for operation of an electrochemical energy converter or an electrolyzer,
the method comprising:
determining, via a computer, a temperature range (T1(i), T2(i)) for at least one subsystem of the coolant system (10),
approximating, via the computer, a temperature-dependent specific heat capacity (cₚ(T)) of a coolant in the at least one subsystem of the coolant system (10) for the determined temperature range (T1(i), T2(i)),
determining, via the computer, a specific enthalpy (h) of the coolant as a function (h(T)) of a temperature (T) based on the approximation, and
operating, via the computer, the coolant system (10) based on the determination.

2. The method according to claim 1,
wherein
the method is performed in real-time during operation of the coolant system (10),
and/or that approximating the temperature-dependent specific heat capacity (cₚ(T)) of the coolant is performed only for the determined temperature range (T1(i), T2(i)).

3. The method according to claim 1,
wherein
the method is performed repeatedly,
and/or that the method is performed incrementally (i).

4. The method according to claim 1,
wherein
the at least one subsystem of the coolant system (10) comprises a coolant path through an electrochemical energy converter or through an electrolyzer,
and/or that the at least one subsystem of the coolant system (10) comprises a coolant path through a cooler (102),
and/or that the at least one subsystem of the coolant system (10) comprises at least one mixing point (14).

5. (canceled)

6. The method according to claim 1,
wherein
prior to approximating the temperature-dependent specific heat capacity (cₚ(T)) of the coolant, a data sheet for the specific heat capacity (cₚ(T)) of the coolant is used based on the temperature (T) to describe the temperature-dependent specific heat capacity (cₚ(T)).

7. The method according to claim 1,
wherein
when approximating the temperature-dependent specific heat capacity (cₚ(T)) of the coolant, a first degree polynomial is used.

8. The method according to claim 1,
wherein
when determining the specific enthalpy (h) of the coolant as a function (h(T)) of the temperature (T), the temperature-dependent specific heat capacity (cₚ(T)) of the coolant is initially approximated over the determined temperature range (T1(i), T2(i)) using a, preferably linear, function and then the approximated, preferably linear, function is analytically integrated.

9. A non-transitory, computer-readable medium comprising instructions which, when executed by a computer, cause the computer to control operation of an electrochemical energy converter or an electrolyzer, by
determining a temperature range (T1(i), T2(i)) for at least one subsystem of a coolant system (10),
approximating a temperature-dependent specific heat capacity (cₚ(T)) of a coolant in the at least one subsystem of the coolant system (10) for the determined temperature range (T1(i), T2(i)),
determining a specific enthalpy (h) of the coolant as a function (h(T)) of a temperature (T) based on the approximation, and
operating the coolant system (10) based on the determination.

10. A control unit (110), comprising a memory in which a code is stored, and a computer, wherein when the code is executed by the computer, the computer controls operation of an electrochemical energy converter or an electrolyzer, by
determining a temperature range (T1(i), T2(i)) for at least one subsystem of a coolant system (10),
approximating a temperature-dependent specific heat capacity (cₚ(T)) of a coolant in the at least one subsystem of the coolant system (10) for the determined temperature range (T1(i), T2(i)),
determining a specific enthalpy (h) of the coolant as a function (h(T)) of a temperature (T) based on the approximation, and
operating the coolant system (10) based on the determination.

11. A fuel cell system (100) comprising a control unit (110) according to claim 10.
